(19) United States
(12) Patent Application Publication
(10) Pub. No.: US 2026/0242024 A1
(43) Pub. Date: Aug. 20, 2026

(54) METHOD FOR DETERMINING AN INFLUENCE OF A POSITION OF A PERSON ON A STEERING MOMENT AS WELL AS VEHICLE

(71) Applicants: Bayerische Motoren Werke Aktiengesellschaft, München (DE); Robert Bosch GmbH, Stuttgart (DE)

(72) Inventors: Martin Flossmann, Waakirchen (DE); Karl Ludwig Stolle, Renningen (DE); Anja Wahl, Markgröningen (DE)

(21) Appl. No.: 19/543,425

(22) Filed: Feb. 18, 2026

(30) Foreign Application Priority Data
Feb. 20, 2025 (DE) 10 2025 106 342.7

(51) Int. Cl. B62J 45/41; B62J 45/20

(52) U.S. Cl. CPC B62J 45/41; B62J 45/20

(57) ABSTRACT

A method for determining at least one influence value, includes characterizing an influence of a relative position between a vehicle and a person (P) using the vehicle on a steering moment currently acting in a steering of the vehicle, in which at least one position value is determined by means of an electronic computing device, which characterizes a measurement variable captured by means of a sensor device and influenced by the relative position between the person (P) using the vehicle and the vehicle. The influence value may be determined depending on the position value.

### RELATED APPLICATIONS

This application claims the benefit under 35 USC 119(a) of German patent application 10 2025 106 342.7 filed on Feb. 20, 2025 in the Deutsches Patent-und Markenamt, the entire disclosure of which is incorporated herein by reference for all purposes.

### FIELD

The following description relates to a method for determining an influence of a relative position between a vehicle and a person using the vehicle on a steering moment acting in a steering of the vehicle. Furthermore, the invention relates to a vehicle.

### BACKGROUND

US 2022/0126833 A1 discloses a method, in which road friction value information is received, which indicates road friction estimations for multiple areas, which surround a vehicle. From U.S. Pat. No. 10,773,725 B1, a method is known, in which images, which show a roadway arranged in front of the vehicle, are determined using sensors of a vehicle. A method for estimating friction coefficients of a wheel of a vehicle in relation to a surface lying beneath can be taken as known from US 2018/0037234 A1. Furthermore, DE 10 2009 002 245 A1 discloses a method for determining the friction value between tires and roadway in a vehicle.

EP 2 290 318 B1 discloses a tilting vehicle. In addition, a steering system for a vehicle is known from DE 10 2019 210 807 A1, with at least one sensor for determining the steering moment. In addition, WO 2020/202262 A1 discloses a driver assistance system for a vehicle. Further, a control device for a motorbike can be taken as known from DE 10 2018 202 019 A1.

All documents cited in the present disclosure, including published documents, patent applications, and patents, may be incorporated herein in their entirety by reference in the same manner as when each cited document is separately and specifically incorporated or incorporated in its entirety.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

It is the object of the present invention to provide a method and a vehicle such that a particularly advantageous operation of the vehicle can be allowed.

In one general aspects, there is provided a method for determining at least one influence value, which characterizes an influence of a relative position between a vehicle and a person (P) using the vehicle on a steering moment currently acting in a steering of the vehicle, in which by means of an electronic computing device at least one position value is determined, which characterizes a measurement variable captured by means of a sensor device and influenced by the relative position between the person (P) using the vehicle, and the vehicle; and the influence value is determined depending on the position value.

In another general aspects, there is provided a vehicle configured to determine at least one influence value, which characterizes an influence of a relative position between a vehicle and a person (P) using the vehicle on a steering moment currently acting in a steering of the vehicle, in which by means of an electronic computing device at least one position value is determined, which characterizes a measurement variable captured by means of a sensor device and influenced by the relative position between the person (P) using the vehicle, and the vehicle; and the influence value is determined depending on the position value.

Other features and aspects will be apparent from the following detailed description, the drawings, and the claims.

### BRIEF DESCRIPTION OF THE DRAWINGS

Further details of the invention are apparent from the following drawings.

FIG. 1 illustrates an example of a schematic side view of a vehicle formed as a single-track two-wheeled vehicle.

FIG. 2 illustrates an example of schematic front view of a person using the vehicle.

Throughout the drawings and the detailed description, unless otherwise described or provided, the same drawing reference numerals refer to the same elements, features, and structures. The drawings may not be to scale, and the relative size, proportions, and depiction of elements in the drawings may be exaggerated for clarity, illustration, and convenience.

### DETAILED DESCRIPTION

A first aspect of the invention relates to a method for determining an influence of a relative position between a vehicle and a person, in particular currently, using the vehicle on a steering moment currently acting in a steering of the vehicle. For example, the person is a rider of the vehicle such that the person, in particular currently, uses the vehicle for example such that the person drives the vehicle, in particular drives it forward. When reference is made hereinafter to the rider, thus, this is to be understood as the person, in particular currently, using the vehicle, unless otherwise indicated. For example, the person, in particular currently, uses the vehicle such that the person is sitting in or on the vehicle. For example, the person is sitting in or on a seat assembly of the vehicle.

The method is performed by means of an electronic computing device. Most particularly, the electronic computing device is an electronic computing device of the vehicle, hence a constituent of the vehicle. By means of the electronic computing device, at least one position value is determined, which characterizes, that is describes or indicates, a measurement variable captured, that is measured, by means of a, in particular electrical and/or electronic, sensor device, which is influenced by the relative position between the person, in particular currently, using the vehicle and the vehicle. In other words, the relative position is a position of the person, in particular currently, using the vehicle relative, that is in relation, to the vehicle. When reference is made hereinafter to the person, thus, this is to be understood as the relative position, unless otherwise indicated. In particular, the relative position is or describes a, in particular current, manner simply also referred to as mode, how or in which the person is, in particular currently, sitting in or on the previously mentioned seat assembly of the vehicle.

The measurement variable and thereby the relative position are captured, that is measured, by means of the sensor device. For example, the electronic computing device receives a, in particular electrical, signal characterizing the relative position captured by means of the sensor device, wherein the electronic computing device for example determines the position value by receiving the signal, in particular in that the signal includes the position value. Further, it is conceivable that the electronic computing device determines, in particular calculates, the position value depending on the signal or from the signal. For example, the sensor device provides the signal. Most particularly, the signal is a measurement signal characterizing the measurement variable captured and thus measured by means of the sensor device. The signal can be a raw signal or the signal is an already processed and/or edited and/or conditioned signal, which is for example processed or conditioned by filtering.

In the method, an influence value is determined by means of the electronic computing device depending on the position value, which characterizes the influence, that is an effect of the relative position between the person, in particular currently, using the vehicle and the steering moment currently acting in the steering. By means of the electronic computing device, the influence value is determined depending on the position value for example such that the position value is used as the influence value. Further, it is conceivable that the influence value is determined by means of the electronic computing device depending on the position value such that the influence value is determined, in particular calculated, from the position value by means of the electronic computing device such that the influence value is for example a value different from the position value, in particular at least with respect to a respective unit of the position value and the influence value.

The invention is based on the realization that the relative position between the vehicle and the person, in particular during a drive of the vehicle, can have a non-negligible influence, that is a non-negligible effect, on the steering moment in particular currently acting in the steering. The invention allows a particularly advantageous consideration of this influence in that the influence value is determined depending on the measured relative position. This means that it is resorted to the relative position measured by means of the sensor device to determine the influence. Hereby, a prerequisite is established to be able to particularly advantageously operate the vehicle, in particular depending on the influence value. In other words, it is thus for example provided in the method that at least one, in particular electrical and/or electronic, component of the vehicle is operated, in particular controlled or regulated, depending on the influence value. Hereby, a particularly advantageous operation of the vehicle can be realized since the in particular current relative position between the person and the vehicle can be or is considered in the operation. From the perspective of the steering moment, the relative position is an influence on the steering moment. Thus, the method according to the invention allows considering the influence on the steering moment by the relative position, in particular in the operation of the vehicle. In particular, the influence value characterizes, describes or defines a steering moment portion, hence a for example dynamic or static torque influencing the steering moment, whereby the invention establishes a prerequisite to be able to particularly advantageously operate the vehicle. In particular, it is the background of the invention that the relative position between the vehicle and the person using the vehicle and thus for example movements of the person for example occurring in relation to the vehicle and thus changes of the position also referred to as position changes and/or weight transfers of the person can cause a torque component, hence a for example dynamic or stationary steering moment portion of the steering moment. In order to allow a particularly advantageous operation of the vehicle, it is advantageous to be able to consider this influence on the steering moment by the relative position and thus for example by the mentioned position changes and/or weight transfers. This is now possible by the invention.

The capture of the measurement variable by the sensor device is not necessarily a constituent of the method according to the invention. It is a constituent of the method according to the invention that the electronic computing device determines the position value and thereby considers the measured measurement variable to be able to determine the influence value and thus the influence on the steering moment by the relative position.

In order to be able to particularly advantageously determine the influence value and thus the influence of the relative position on the steering moment, it is provided in an embodiment of the invention that the measurement variable is captured, that is measured, by means of the sensor device. For example, at least or exactly one sensor is or surrounds the sensor device, by means of which the measurement variable influenced by the relative position is measured, that is captured. Hereby, the relative position can be particularly advantageously determined, whereby the influence value can be particularly advantageously determined. Hereby, a basis is provided to be able to particularly advantageously operate the vehicle.

In particular, it is possible to consider a non-neutral relative position between the vehicle and the person in the operation of the vehicle by determining the influence value and thus for example by considering the influence value and thus the relative position. In other words, the in particular current relative position between the person and the vehicle can be a so-called neutral seating position or else a so-called non-neutral seating position of the person. If the in particular current relative position is the neutral seating position, thus, the influence of the relative position on the steering moment is very low or even zero. However, if the in particular current relative position is the so-called non-neutral seating position, thus, the relative position can have a non-zero, very large influence on the steering moment. Now, the method allows particularly well considering this influence such that a particularly advantageous operation of the vehicle can be realized. In particular, the influence value is or describes the previously mentioned steering moment portion resulting from the relative position, which is an in particular current portion of the in particular current steering moment. Most particularly, it is possible to eliminate this steering moment portion resulting from the relative position from of the steering moment, for example by subtraction, such that a variable can be determined, which characterizes a torque in particular currently acting in the steering without the steering moment portion resulting from the relative position.

Since the person can be the rider of the vehicle and since the person is sitting in or on the mentioned seat assembly of the vehicle, the relative position is also referred to as rider position. In particular, it is the background of the invention that simulations and measurements have shown that the influence of the rider position on the steering moment should not be neglected and consequently be eliminated with respect to its order of magnitude in particular upon or in lateral-dynamic maneuvers. The method according to the invention allows this since the method according to the invention, based on the position value or the measurement variable, which characterizes the in particular current rider position, determines the influence value, hence the steering moment portion, which is for example required due to the current rider position or acts in the steering and therein is for example not introduced into the steering in that the person introduces the steering moment portion, which is also referred to as steering moment portion, into the steering via their arms.

A rider of the vehicle usually controls lateral dynamics of a vehicle and thereby a lane, in or on which the vehicle, in particular currently, drives, at least substantially by the steering moment, which the rider adjusts via a steering handle for example formed as a steering bar or steering wheel, in particular such that the rider exerts the steering moment or a torque influencing the steering moment on the steering handle via their arms. In particular if the vehicle is formed as a single-track two-wheeled vehicle, in particular as a motorbike, however, the transverse dynamics can also be influenced by the relative position between the vehicle and the rider, hence by a center of gravity shift of the rider, albeit to a lower extent than by exerting a force or a torque on the steering.

On the assumption that the person is sitting in a seating point in or on the seat assembly of the vehicle seat, thus, by a lateral displacement, in particular shift, of the seating point hence effected in vehicle transverse direction of the vehicle, with respect to the vehicle vertical direction of the vehicle also referred to as vertical axis, the vehicle vertical direction of which for example extends through the center of mass of the vehicle also simply referred to as center of gravity, and by adjusting a, in particular relative, angle lean of the torso of the person to the vehicle vertical direction of the vehicle also referred to as vertical axis, a center of gravity shift in a plane of the vehicle also referred to as y-z plane results, wherein the plane is spanned by the vehicle transverse direction (y-direction) and the vehicle vertical direction (z-direction). A lateral offset of the seating point thus extending in vehicle transverse direction of the vehicle to the vehicle vertical direction of the vehicle preferably extending through the center of gravity of the vehicle and most preferably extending straight is denoted by r_{offs}. If the seating point is not shifted, that is offset, in vehicle transverse direction of the vehicle with respect to the vehicle vertical direction, thus, the lateral offset r_{offs} hence extending in vehicle transverse direction is zero. In other words, the seating point is then on the vehicle vertical direction, which is also referred to as vertical axis or vehicle vertical axis. The vehicle transverse direction extends along an imagined straight line and is also referred to as transverse axis or vehicle transverse axis. However, if the seating point is shifted, hence offset, in vehicle transverse direction, hence along the transverse axis with respect to the vehicle vertical direction, hence with respect to the vertical axis, thus, the lateral offset r_{offs} has a non-zero value. The mentioned angle rₗₑₐₙ extends in the mentioned y-z plane, hence is an angle viewed in this plane. If the torso of the person in particular currently using the vehicle is not laterally inclined, that is in vehicle transverse direction with respect to the vehicle vertical direction, hence with respect to the vertical axis, viewed in the plane, thus, the angle rₗₑₐₙ is zero. However, if the torso of the person in particular currently using the vehicle is laterally inclined, that is in vehicle transverse direction with respect to the vehicle vertical direction, viewed in the plane, thus, the angle rₗₑₐₙ has a non-zero value, in particular in the unit “degree”. If the lateral offset r_{offs} has a non-zero value and/or if the angle rₗₑₐₙ also referred to as relative torso angle has a non-zero value, thus, the in particular current relative position between the person and the vehicle is the previously mentioned, non-neutral seating position, which is also referred to as non-neutral rider seating position or non-neutral position. If the lateral offset r_{offs} is zero and if, in particular at the same time, the relative angle rₗₑₐₙ is zero, thus, the current relative position is the previously mentioned, neutral seating position, which is also referred to as neutral rider seating position or neutral position.

In particular if the vehicle is a single-track two-wheeled vehicle, the rider of the vehicle can follow one and the same curve course both with neutral rider seating position and with non-neutral rider seating position, however, the rider therein has to adjust different steering moments, hence exert different torques or forces on the steering via their arms. In the following, reference is made only to the rider, wherein the female rider of the vehicle is also to be understood thereby. With neutral seating position, the rider for example adjusts a torque denoted by Mₙₑᵤₜᵣₐₗ to follow a curve. This means that with neutral seating position, the rider exerts the torque Mₙₑᵤₜᵣₐₗ on the steering handle via their arms to follow the curve, that is to steer the vehicle and thereby drive it along the curve. With non-neutral seating position, the rider adjusts a torque denoted by M_{non_neutral} to follow the same curve. In other words, with non-neutral seating position, the rider exerts the torque M_{non_neutral} on the steering handle via their arms to follow the same curve, that is to steer the vehicle and thereby drive it along the same curve. Therein, M_{non_neutral} is dependent on r_{offs} and rₗₑₐₙ, such that it applies:

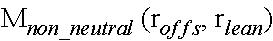

Corresponding to the equation (1) below, M_{non_neutral} differs from Mₙₑᵤₜᵣₐₗ by dM_{riderpos}, the steering moment portion, which is required due to the non-neutral rider seating position.

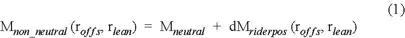

Comprehensive simulation studies have shown that dM_{riderpos} approximately linearly depends on r_{offs} and Clean in the normal driving range.

In a variant, dM_{riderpos} can be determined for a measured seating position (r_{offs}, rₗₑₐₙ) via the following relation depending on r_{offs} and rₗₑₐₙ.

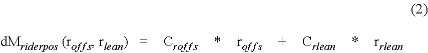

Constants are denoted by C_{roffs} and Cᵣₗₑₐₙ above, which can for example be identified with simulation data. The simulation data for example includes a description of an overall system, which includes the vehicle optionally in addition with cargo with load attached thereto as well as the person using the vehicle. For all of the combinations of vehicle, loading state of the vehicle and weight of the person using the vehicle resulting from it, the above mentioned constants C_{roffs} and Cᵣₗₑₐₙ can be determined and for example be stored in look-up tables and/or characteristic maps depending on the simulation data. The look-up tables are also referred to as lookup tables. For example, the constants C_{roffs} and Cᵣₗₑₐₙ can also be determined, in particular estimated, by means of interpolation methods for combinations of vehicle, loading state and weight of the person, not explicitly simulated and thus not explicitly contained in the look-up tables.

Further, the previously mentioned steering moment portion, hence the influence value and a value characterizing the influence value, is denoted by dM_{riderpos}.

A further variant, by which a non-linear dependency of dM_{riderpos} on r_{offs} and rₗₑₐₙ can also be described, is the storage of a 2-dimension look-up table, in which the steering moment portion dM_{riderpos_i}(r_{offs_i}, r_{lean_i}) due to the non-neutral rider seating position is stored for pairs of values (r_{offs_i}, r_{lean_i}). By means of interpolation methods, the value dM_{riderpos}(r_{offs}, rₗₑₐₙ) for a measured pair of values (r_{offs}, rₗₑₐₙ) can be read out.

Very generally, the steering moment to be adjusted in cornering is dependent on the speed v and the leaning position φ of the motorbike required for cornering. I.e., M_{non_neutral}, Mₙₑᵤₜᵣₐₗ and thus also dM_{riderpos} are dependent on v and q.

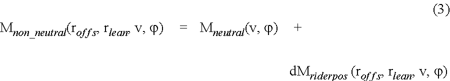

A more accurate modeling of the steering moment portion dM_{riderpos} also considers v and φ besides r_{offs} and rₗₑₐₙ.

In a further variant, the steering moment portion dM_{riderpos}(r_{offs}, rₗₑₐₙ, v, φ) is determined corresponding to equation (4), wherein the variables C_{roffs} and Cᵣₗₑₐₙ depend on the speed v and the leaning position φ of the motorbike and are determined corresponding to equation (5).

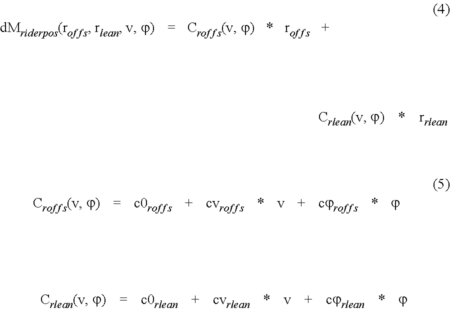

The constants c0_{roffs}, cv_{roffs}, cφ_{roffs}, c0ᵣₗₑₐₙ, cvᵣₗₑₐₙ and cφᵣₗₑₐₙ can e.g. be identified with the aid of simulation data.

The simulation data includes a description of the overall system consisting of the motorbike, optionally additionally attached cargo with load as well as the rider. For all of the combinations of motorbike, loading state and rider weight resulting therefrom, the constants c0_{roffs}, cv_{roffs}, cφ_{roffs}, c0ᵣₗₑₐₙ, cvᵣₗₑₐₙ and cφᵣₗₑₐₙ can be determined and stored in look-up tables depending on the simulation data. By means of interpolation methods, the constants c0_{roffs}, cv_{roffs}, cφ_{roffs}, c0ᵣₗₑₐₙ, cvᵣₗₑₐₙ and cφᵣₗₑₐₙ can also be estimated for not explicitly simulated combinations of motorbike, loading state and rider weight.

A further variant, by which a non-linear dependency of dM_{riderpos} on r_{offs}, rₗₑₐₙ, v and φ can also be described, is the storage of a 4-dimensional look-up table, in which the steering moment portion dM_{riderpos_i}(r_{offs_i}, r_{lean_i}, V_i, φ_i) due to the non-neutral rider seating position is stored for quadruples of values (r_{offs_i}, r_{lean_i}, V_i, P_i). By means of interpolation methods, the value dM_{riderpos}(r_{offs}, rₗₑₐₙ, v, φ) can be read out for a measured quadruple of values (r_{offs}, rₗₑₐₙ, v, φ).

The previously mentioned steering moment currently acting in the steering of the vehicle is a torque also referred to as steering torque, which for example acts about a steering axis.

For example, the vehicle comprises at least or exactly one vehicle wheel. In particular, the vehicle comprises at least or exactly two vehicle wheels, in particular if the vehicle is formed as a single-track two-wheeled vehicle. The vehicle wheel is a ground contact element, via which the vehicle can be or is downwardly supported in vehicle vertical direction of the vehicle on a ground, in particular during the method. In particular, it is conceivable that the method is performed upon a drive of the vehicle, which is driven along the ground in the drive and is downwardly supported on the ground via the ground contact element in vehicle vertical direction. Therein, the ground contact element, in particular directly, rolls on the ground. The ground is also referred to as terrain and is formed by a terrain. The vehicle wheel is also simply referred to as wheel. In particular, the vehicle wheel for example includes a rim and a tire in particular formed separately from the rim, which is fitted onto the rim and thus carried by the rim. For example, the tire is formed of rubber. In particular, the vehicle wheel is rotatably retained on a component about a wheel rotational axis in relation to the component of the vehicle, wherein it is in particular provided that the vehicle wheel, in particular directly, rolls on the ground and therein rotates about the wheel rotational axis in relation to the component during the method. In particular, the component is a steering element of the steering of the vehicle for example formed as a fork, in particular front fork, wherein the steering element is for example pivotably retained on a chassis about the pivot axis also referred to as steering axis in relation to the chassis of the vehicle for example formed as a frame, in particular as a lattice frame. Therein, the vehicle wheel for example formed as a front wheel is pivotable with the steering element about the steering axis in relation to the chassis.

By pivoting the steering element and thus the vehicle wheel effected about the steering axis and in relation to the chassis, the vehicle can be steered, hence cornering maneuvers, driving direction changes and roadway or lane changes of the vehicle can be effected thereby. For example, the person using the vehicle can pivot the steering element and the vehicle wheel with it about the steering axis in relation to the chassis to thereby steer the vehicle, hence to thereby cause cornering maneuvers, driving direction changes and lane or roadway changes of the motor vehicle. Hereto, the person, in particular while sitting in the seat assembly, exerts a force or a torque on the steering element via their arms, wherefrom the steering moment currently acting in the steering results. For example, the steering element is the previously mentioned steering handle.

The torque capable of being exerted or exerted on the steering element and thus on the steering by the person via their arms, hence capable of being introduced or introduced into the steering, is also referred to as person moment or person torque. Thus, the steering moment is for example a torque acting about the steering axis, which for example acts in the steering in that the person exerts the person moment on the steering, in particular on the steering element and via the steering element on the steering, in particular with their arms or hands. For example, the steering moment is the person moment, in particular if r_{offs} and rₗₑₐₙ, are zero, in particular at the same time. Further, it is conceivable that the steering moment results from the person moment. The steering moment in particular results from the person moment if the steering moment is the person moment, hence if r_{offs} and rₗₑₐₙ, are zero, in particular at the same time. Further, the steering moment can result from the person moment and from the steering moment portion resulting from the relative position, in particular if r_{offs} and/or rₗₑₐₙ is or are unequal to zero. Then, the steering moment is composed at least of the person moment and of the steering moment portion resulting from the relative position, since the person takes the non-neutral seating position, which influences the steering moment. If r_{offs} and rₗₑₐₙ are zero, in particular at the same time, thus, the relative position does not influence the steering moment.

Thus, the previously denoted steering moment, which is exerted on the steering by the person via their arms and thus introduced into the steering, is for example the mentioned person moment.

In order to be able to particularly advantageously capture the relative position and thus to be able to particularly advantageously determine the influence of the relative position on the steering moment, it is provided in further configuration of the invention that a sensor device of the vehicle is used as at least a part of the sensor device.

A further embodiment is characterized in that a sensor device arranged at the person is used as at least a part of the sensor device, whereby the relative position can be particularly advantageously measured.

In order to be able to capture the relative position in particularly advantageous manner and in particular in particularly comfortable and simple manner for the person, it is provided in further configuration of the invention that a sensor device arranged on at least one piece of clothing of the person is used as at least a part of the sensor device, wherein the person wears the piece of clothing during the method and thus on their body.

In order to be able to allow a particularly advantageous operation of the vehicle, it is provided in further configuration of the invention that at least one actual torque value is determined by means of the electronic computing device, which is most preferably a constituent of the vehicle, which characterizes, that is indicates or describes, the current steering moment acting in the steering of the vehicle, wherein the actual torque value is determined by means of the electronic computing device in that the actual torque value is determined depending on the influence value by means of the electronic computing device. Therein, it is preferably provided that the at least one component of the vehicle is operated depending on the actual torque value.

For example, the steering moment, in particular currently, acting in the steering is captured by means of a capturing device, in particular of the vehicle. Therein, the capturing device for example provides an in particular electrical capturing device signal, wherein the electronic computing device for example receives the capturing device signal. The capturing device signal characterizes the steering moment captured by means of the capturing device, such that the capturing device signal for example includes the actual torque value. In that the electronic computing device receives the capturing device signal, the electronic computing device for example determines the actual torque value. Further, it is conceivable that the electronic computing device receives the capturing device signal and determines, in particular calculates, the actual torque value depending on the received capturing device signal.

In order to be able to realize a particularly advantageous operation of the vehicle, it is provided in a further embodiment that at least one, in particular current, variable is determined by means of the electronic computing device, which characterizes a current friction between the previously mentioned vehicle wheel and the current terrain forming the ground, on which the vehicle wheel is for example currently downwardly supported in vehicle vertical direction of the vehicle. The variable for example includes at least one actual friction value characterizing the current friction and/or at least one friction value class characterizing the current friction, or the variable is an actual friction value characterizing the current friction or the variable is a friction value class characterizing the current friction. In particular, the friction characterized by the variable is a friction between the vehicle wheel, in particular a contact point or a contact area of the vehicle wheel, and a terrain area of the terrain, wherein the vehicle wheel, in particular directly, contacts the terrain area in the contact point or the contact area. In particular, the terrain area extends in a terrain plane also referred to as roadway plane, which can for example extend obliquely or else perpendicularly to the vertical.

In the method, at least one actual angle value is determined by means of the electronic computing device, which characterizes a current roll angle of the vehicle. A movement of the vehicle about the vehicle longitudinal direction thereof also referred to as longitudinal axis or vehicle longitudinal axis is to be understood by rolling, wherein the roll angle is an angle, about which the vehicle, in particular currently, rolls in particular related to an initial position referred to as neutral position, hence is inclined about the vehicle longitudinal axis simply also referred to as longitudinal axis. Basically, it is conceivable that the current roll angle and thus for example the actual angle value are zero such that the vehicle is in the mentioned initial position, or else the current roll angle is a non-zero value, by which the vehicle is currently inclined about the longitudinal axis in particular in vehicle transverse direction such that the vehicle is for example currently in an inclination position different from the neutral position viewed about the longitudinal axis and such that the actual angle value for example is a non-zero value. For example, the current roll angle is calculated by means of the electronic computing device. Further, it is conceivable that the current roll angle is captured by means of the capturing device of the vehicle, wherein the actual angle value characterizes the current roll angle captured by means of the capturing device.

In the method, at least one actual speed value is for example determined by means of the electronic computing device, which is also referred to as control device, which characterizes a current driving speed simply also referred to as speed of the vehicle, which drives, in particular forward, along the terrain in particular during the method, in particular while the vehicle is downwardly supported on the terrain via the vehicle wheel in vehicle vertical direction of the vehicle, such that the vehicle wheel, in particular directly, rolls on the terrain. In particular, the current driving speed of the vehicle and thus for example the actual speed value are non-zero and in particular greater than zero, such that the vehicle is for example driven, in particular forward, along the terrain with the driving speed during the method or in the method. For example, the current driving speed of the vehicle is measured by means of the capturing device of the vehicle, such that the actual speed value for example characterizes, that is indicates, describes or defines, the current, measured driving speed. The determined actual angle value is associated with the determined actual speed value and vice versa, such that the determined actual angle value and the determined actual speed value form an actual pair of values. Hereby, it is not necessarily to be understood that the electronic computing device forms the mentioned actual pair of values from the actual angle value and the actual speed value, hence the electronic computing device does not necessarily perform a special computing step to form the actual pair of values from the actual angle value and the actual speed value or to associate the actual angle value and the actual speed value with the actual pair of values or the like, but the determined actual angle value and the determined actual speed value are basically regarded as values forming the mentioned actual pair of values. This is in particular the case to be able to illustratively comprehensibly describe the method below based on the term “actual pair of values”.

In the method, by means of the electronic computing device, depending on the actual pair of values, that is depending on the actual angle value and depending on the actual speed value, one of the reference pairs of values is selected as the pair of values associated with the actual pair of values from at least one reference characteristic map determined for a reference friction value, which includes multiple reference angle values, multiple reference speed values and multiple reference torque values, and in order to associate exactly one of the reference torque values with a respective reference pair of values, which includes exactly one of the reference angle values and exactly one of the reference speed values. Thus, the reference characteristic map is for example an at least or exactly three-dimensional characteristic map, which quasi indicates the reference torque values across the reference angle values and across the reference speed values. Therein, it is conceivable that multiple of the reference pairs of values are associated with the respective reference torque value. It is further conceivable that the same reference angle value is a part of multiple of the reference pairs of values. Further, it is conceivable that the same reference speed value is a part of multiple of the reference pairs of values. By the feature that the respective reference pair of values includes exactly one of the reference angle values and exactly one of the reference speed values and by the feature that, in particular exactly, one of the reference pairs of values is selected as the pair of values associated with the actual pair of values, it does not necessarily have to be understood that the reference pairs of values, hence the reference angle values and the reference speed values, as the reference pairs of values are actually stored and contained in the reference characteristic map, but the term “reference pair of values” is first only used to be able to illustratively and comprehensibly describe the method in the following. Thus, in particular by the feature that depending on the actual pair of values, hence depending on the actual speed value and depending on the actual angle value, in particular exactly, one of the reference pairs of values is selected, it is to be understood that depending on the actual pair of values, hence depending on the actual speed value and depending on the actual angle value, in particular exactly, one of the reference angle values and, in particular exactly, one of the reference speed values are selected, wherein the selected reference angle value and the selected reference speed value are associated with the determined actual pair of values, hence with the determined actual angle value and with the determined actual speed value, and for example form the only imagined reference pair of values.

By means of the electronic computing device, the reference torque value associated with the selected reference pair of values is determined, in particular read out of the reference characteristic map, which is also simply referred to as characteristic map. This means that, in particular exactly, one of the reference torque values is determined by means of the electronic computing device depending on the selected reference angle value and depending on the selected reference speed value.

By means of the electronic computing device, the determined reference torque value is compared to the actual torque value. In other words, a comparison is performed by means of the electronic computing device, in which the determined reference torque value is compared to the determined actual torque value.

By means of the electronic computing device, the variable is determined depending on the comparison of the reference torque value to the actual torque value. Further, it is preferably provided that at least one component of the vehicle, that is at least one function of the vehicle, is operated, in particular controlled or regulated, depending on the determined variable by means of the electronic computing device in the method.

In particular, the following realizations and considerations underlie the invention: For a high number of vehicle and driver assistance systems of a vehicle, information about a present friction value or a present friction value class between the vehicle wheel and the terrain, in particular in the contact surface between the vehicle wheel and the terrain, is of importance. This in particular applies to vehicle and driver assistance systems, which relate to the vehicle dynamics. In existing applications, the friction value utilized at the current point of time or the current friction value class is usually estimated, mostly using measured inertial variables, which for example include accelerations of the vehicle and/or rotational rates of the vehicle. However, this usually cannot provide the information of the friction value maximally available at the current point of time or the friction value class maximally available at the current point of time. For this, an assumption is mostly made or it is estimated by intentionally exceeding the maximally transferrable tire forces (limit range), for example in an antilock braking system (ABS). A further background is in that both the kinematics of cornering and the kinetics of the steering also referred to as steering system basically differ with regard to forces and torques simply also referred to as moments in the steering system during cornering for example for single-track two-wheeled vehicles for example formed as motorbikes from those of automobiles such as for example passenger cars. Therefore, methods known from the prior art, which are not based on sensing the environment, cannot be transferred to the estimation of the maximum friction value for example for single-track two-wheeled vehicles. In contrast, the invention utilizes the determination, in particular a measurement, of the steering moment acting in the steering (steering system), which in particular acts about the previously mentioned steering axis.

Furthermore, the invention assumes that in today's series-production vehicles such as for example series-production two-wheeled vehicles, which are in particular formed single-track, information about the in particular currently and preferably maximally possible friction value in the contact surface between the vehicle wheel, in particular the tire, and the terrain is not available since a method for determining this variable, in particular during a normal drive also referred to as road drive, does not exist heretofore. However, the friction value, in particular the maximally possible friction value, between the vehicle wheel and the terrain can represent a variable, which can be used for improving existing safety and assistance systems and for future safety and assistance systems compared to conventional solutions. Therein, the invention allows a, in particular continuous, determination, in particular a, in particular continuous, estimation of the variable and thus of the current friction between the vehicle wheel and the current terrain. Thus, it is preferably provided that the variable determined by means of the method characterizes, that is indicates, describes or defines, the currently maximally possible friction value between the vehicle wheel and the terrain or the currently maximally possible friction value class between the vehicle wheel and the terrain. Therein, the invention utilizes the steering moment, hence the actual torque value, and uses, in particular if the vehicle is a preferably single-track two-wheeled vehicle, at least one or more characteristics specific to two-wheeled vehicles. The variable determined by the method according to the invention can for example be provided to at least one or more, other functions of the vehicle such that the at least one, other function and thus for example the previously mentioned component can for example be operated depending on the determined variable. In particular, the component or the function is a warning and/or intervening function, which is for example used for stabilizing a current driving state of the vehicle. An exemplary situation is a drive on a regular route with typically always comparable lean position structure/profile in cornering. If a reduced friction value or a reduced friction value class between tire and road, hence between vehicle wheel and terrain, is present on a day, it is possible that this friction value or this friction value class does not allow the usually driven lean positions. If this friction value in particular reduced with respect to a usual friction value or this friction value class in particular reduced with respect to a usual friction value class is recognized, in particular by means of the method, by means of which the reduced friction value and/or the reduced friction value class is determined as the variable or by determining the variable, the drive of the vehicle can for example be assisted by at least one system of the vehicle in particular formed as a driver assistance system, for example by reducing the driving speed and/or the rider of the vehicle can be warned, in particular in that a haptically and/or optically and/or acoustically perceivable indication signal is output, by which the determined variable is communicated to the rider. In particular, the indication signal is for example output by means of an electrically operable and most particularly electronic playback device of the vehicle. Thus, the playback device can for example be the mentioned component.

In the following, the method according to the invention is further explained based on an example: The rider of the vehicle for example formed as a single-track two-wheeled vehicle, in cornering, in which the vehicle is driven through a curve and the method according to the invention is performed, supports, with a torque also referred to as rider steering moment exerted by the rider on the steering system (steering), which acts as the mentioned steering moment in the steering system or from which the steering moment acting in the steering results, a plurality of torques acting on the steering system (steering). The latter can either directly act as a torque or result from forces acting through corresponding lever arms. If in a first cornering, in which the vehicle preferably formed as a single-track two-wheeled vehicle is for example driven through a curve with a first driving speed and a first roll angle, wherein the friction between the vehicle wheel and the terrain, which forms the curve, for example has a first actual value, and if the vehicle is for example driven in a second cornering preceding in time to the first cornering or subsequent to the first cornering, through the same curve with the same, first roll angle and the same, first driving speed, however, while the friction between the vehicle wheel and the terrain has a second actual value different from the first actual value, thus, the rider has to apply a different steering moment and exert it on the steering system in the second cornering than in the first cornering such that the steering moment for example has a first actual torque value in the first cornering and a second actual torque value different from the first actual torque value in the second cornering. In other words, the invention exploits that with identical roll angle and identical driving speed, but different friction values or actual values of the friction, the steering moment changes or has to change, since individual torques acting on the steering system or also torque or steering moment portions of the steering moment and therein in particular the so-called tire torsion moment T_{z} change at different friction values. The tire torsion moment results due to a deformation of the tire in a drive of the vehicle for example in particular formed as a single-track two-wheeled vehicle in leaning position, that is in particular if the roll angle or the actual angle value is different from 0. This effect that different steering moments are adjusted, hence act in the steering system, with basically identical cornering, but with or on different friction values, is utilized in the method according to the invention formed as friction value recognition or friction value determination, in particular in that the actual torque value is determined, for example in that the steering moment is measured, hence captured, in particular with a steering moment sensor technology of the vehicle.

The basis of the friction value recognition according to the invention is the at least one reference characteristic map, which is also referred to as steering moment characteristic map. The reference characteristic map for example maps for a stationary cornering or circular travel on known friction value for example formed as a high friction value in the form of the reference friction value, for which the reference characteristic map has been determined, the steering moment to be adjusted in the form of the reference torque values across the driving speed in the form of the reference speed values and the roll angle in the form of the reference angle values. For example, the reference characteristic map can be expressed by M_{KF_μ(v,φ)}, wherein the driving speed is denoted by v, the roll angle is denoted by q and the steering moment is denoted by M_{KF_μ}. For example, the reference characteristic map can be stored in an in particular electrical or electronic data memory, in particular of the electronic computing device. The reference characteristic map can for example be determined, in particular calculated, from measurement signals, which are recorded under defined experimental conditions such as for example known friction value, pressure in the tire also referred to as tire pressure etc. for stationary and/or quasi-stationary circular travels or cornering maneuvers and/or determined with the aid of a validated simulation environment.

In order to be able to determine the variable and consequently the current, in particular maximally possible, friction between the vehicle wheel, in particular the tires thereof, and the terrain, it is provided in an embodiment of the invention that the actual torque value is determined by means of the electronic computing device, in that at least one first initial value is determined by means of the electronic computing device, which characterizes at least a dynamic steering moment portion acting in the steering system (steering) and a stationary steering moment portion acting in the steering. Thus, the first initial value for example is or describes a sum of the at least one dynamic steering moment portion acting in the steering and the stationary steering moment portion acting in the steering. In particular, the at least one first initial value describes or characterizes the stationary steering moment portion and multiple, in particular all, dynamic steering moment portions acting in the steering, in particular such that the stationary steering moment portion and the at least one, dynamic steering moment portion, in particular the dynamic steering moment portions, in total result in the first initial value. In addition, the actual torque value is for example determined by means of the electronic computing device in that at least one second initial value is determined by means of the electronic computing device, which characterizes exclusively the at least one dynamic steering moment portion acting in the steering related to the at least one dynamic steering moment portion acting in the steering and the stationary steering moment portion acting in the steering. In order to determine the actual torque value, the actual torque value is determined depending on the initial values by means of the electronic computing device, in particular in that the second initial value is subtracted from the first initial value.

In order to be able to particularly advantageously determine the actual torque value and thus consequently the variable from the initial values, it is provided in further configuration of the invention that the second initial value is calculated by means of the electronic computing device depending on a rotational speed of the vehicle wheel and/or at least one further vehicle wheel of the vehicle and/or depending on a roll rate of the vehicle and/or depending on a roll acceleration of the vehicle and/or depending on a yaw acceleration of the vehicle and/or depending on a steering angle rate of the vehicle and/or depending on a deceleration, hence negative acceleration of the vehicle, in particular acting in vehicle longitudinal direction of the vehicle, and/or depending on a pressure in at least one wheel brake of the vehicle and/or depending on a gyroscopic moment of the vehicle also referred to as gyroscopic torque. For example, the rotational speed of the vehicle wheel is captured by means of a rotational speed sensor. The roll rate of the vehicle is the first time derivative of the roll angle, and the roll acceleration of the vehicle is the second time derivative of the roll angle, hence the first time derivative of the roll rate. The yaw acceleration is the first derivative of a yaw angle of the vehicle in particular acting about the vehicle vertical direction of the vehicle. The deceleration of the vehicle results for example from braking the vehicle. The wheel brake is for example associated with the vehicle wheel and formed to brake the vehicle wheel and thus the motor vehicle. Thus, the wheel brake for example formed as a friction brake is a service brake of the vehicle.

A further background of the invention is in particular that stationary cornering maneuvers and/or circular travels occur only rarely or not at all in the real road traffic. In order to, in particular continuously, determine the variable and thus for example to perform, an in particular continuous, friction value classification/recognition, therefore, the dynamic steering moment portion is eliminated from the first initial value for example determined by measuring, that is by capturing, in particular in that the second initial value is subtracted from the first initial value. In particular by subtracting the second initial value from the first initial value, a stationary value is determined, in particular calculated and most particularly estimated, wherein the stationary value characterizes, that is describes, indicates or defines, the stationary steering moment portion related to the at least one dynamic steering moment portion and the at least one stationary steering moment portion. The stationary value is for example denoted by M_{stationär}, wherein the first initial value is for example denoted by Mₘₑₛₛ and the second initial value is denoted by M_{dynamisch}. Thus, M_{stationär} for example results from: M_{stationär}=Mₘₑₛₛ−M_{dynamisch}. In particular, M_{dynamisch}, hence the second initial value, is, characterizes or describes a sum of individual, multiple dynamic steering moment portions. For example, the in particular current steering moment is captured, hence measured, by means of the sensor device, whereby the first initial value is determined. Hereto, the sensor device for example provides an in particular electrical moment signal, which characterizes the measured steering moment and therein for example the first initial value. The electronic computing device can receive the moment signal and thereby determine the first initial value. Further, it is conceivable that the electronic computing device receives the moment signal and determines the first initial value from the or depending on the moment signal. For example, the moment signal is the sensor device signal or a part of the sensor device signal or a further signal.

The actual torque value is determined depending on the initial values, for example, as described above, in that the second initial value is subtracted from the first initial value. For example, the stationary value (M_{stationär}) is used as the actual torque value, which is compared to the reference torque value read out of the reference characteristic map for the in particular measured driving speed and the in particular measured roll angle also referred to as leaning position angle, hence for the actual speed value and the actual angle value. For example, the actual speed value is determined by measuring the driving speed. Alternatively or additionally, the actual angle value is for example determined by measuring the roll angle. For example, the driving speed and/or the roll angle can be measured by means of the sensor device of the vehicle.

In the or by the comparison of the reference torque value to the actual torque value, a difference between the reference torque value and the actual torque value is in particular determined, in particular calculated. If the difference is for example 0, thus, the variable, in particular the actual friction value, for example is or includes the reference friction value, for which the reference characteristic map has been determined. If the actual torque value is for example greater than the reference torque value, and the difference therein for example exceeds a for example presettable or preset threshold value, thus, it can be inferred that the variable, in particular the actual friction value, is lower than the reference friction value. However, it the actual torque value is for example smaller than the reference torque value and the difference therein for example exceeds the threshold value and/or a further threshold value, thus, it can be inferred that the variable, in particular the actual friction value, is greater than the reference friction value. Hereby, the actual friction value can be advantageously determined in particular during a drive of the vehicle. Thus, a reference variable can for example be understood by the reference friction value, which can include at least one reference value and/or at least one reference class, or the reference variable is a reference value or the reference variable is a reference class.

In order to be able to particularly advantageously determine the variable, it is provided in further configuration of the invention that a torque acting in the steering, in particular the steering moment, is captured by means of the sensor device of the vehicle, wherein the actual torque value is determined depending on the captured torque. As already described above, the sensor device for example provides the in particular electrical moment signal, which characterizes the torque captured by means of the sensor device, acting in the steering, in particular the steering moment. The electronic computing device for example receives the moment signal, wherein the electronic computing device determines, in particular calculates, the actual torque value depending on the received moment signal. Hereby, the actual torque value can be particularly advantageously determined such that the variable can be particularly advantageously determined as a consequence.

In order to be able to particularly advantageously determine the variable, it is provided in further configuration of the invention that the first initial value is determined depending on the torque captured by means of the sensor device, in particular by means of the electronic computing device. For example, the first initial value characterizes the torque captured by means of the sensor device, in particular for example such that the moment signal includes the first initial value. Thus, the electronic computing device for example determines the first initial value in that the electronic computing device receives the moment signal. Further, it is conceivable that the electronic computing device receives the moment signal and determines the first initial value depending on the moment signal. For example, the actual torque value is determined, in particular calculated and thus for example estimated, from the initial values such that the second initial value is subtracted from the first initial value, whereby the actual torque value and the variable can be particularly advantageously determined.

M_{dynamisch}, hence the second initial value, for example is composed of individual, multiple dynamic steering moment portions. In other words, the second initial value for example characterizes or describes multiple, dynamic steering moment portions. The dynamic steering moment portions are for example calculated depending on in particular measured driving dynamics variables like wheel rotational speed, roll rate, roll acceleration, yaw acceleration, steering angle rate, deceleration, wheel brake pressure etc. and for example depending on in particular known vehicle parameters like mass inertia of the vehicle wheel for example formed as a front wheel, steering head angle etc. The in particular measured driving dynamics variables are for example correspondingly filtered in advance depending on their respective signal quality. Further, it is conceivable that the torque measured by means of the sensor device, in particular steering moment, is filtered such that the actual torque value is determined depending on the filtered torque, in particular steering moment.

An essential one of the dynamic steering moment portions can for example be the gyroscopic moment M_{dyn_gyro} of the vehicle wheel rotating with the wheel rotational speed ω_{VR} occurring at a roll rate of the vehicle also denoted by \dot{φ} and to be supported, wherein the gyroscopic moment M_{dyn_gyro} is calculated as follows: M_{dyn_gyro}=J_{VR}*cos (ε)*ω_{VR}*\dot{φ}. Therein, J_{VR} denotes the mass inertia of the vehicle wheel for example formed as the front wheel, and ε denotes the dynamic steering head angle. For example, if a steering angle or steering rate sensor is available, by means of which a steering angle of the vehicle or the steering angle rate can be captured, thus, depending on the steering angle rate denoted by \dot{δ}, a dynamic steering moment portion M_{dyn_ddelta} resulting from the steering angle rate can also be calculated as follows: M_{dyn_ddelta}=k_{δ}·*\dot{δ}. The mentioned steering angle is an angle, by which the steering element and with it the vehicle wheel is, in particular currently pivoted, hence steered, about the pivot axis. The steering angle rate is the first time derivative of the steering angle. Therein, k_{δ}· denotes a damping of the steering also referred to as steering damping. Usually, the dynamic moment portion M_{dyn_ddelta} is very low such that it does not necessarily have to be calculated. Further dynamic portions can for example be included by the roll acceleration, the yaw acceleration and the deceleration of the vehicle for example formed as a longitudinal deceleration, hence acting in vehicle longitudinal direction of the vehicle, etc. which can for example cause further dynamic steering moment portions.

One of the dynamic steering moment portions can further be a steering moment portion, which results from the roll acceleration of the vehicle denoted by \ddot{φ} and is denoted by M_{dyn_ddphi}. This dynamic steering moment portion M_{dyn_ddphi} caused by the roll acceleration is for example given by the following linear correlation: M_{dyn_ddphi}=k_{ddphi}*\ddot{φ}. Therein, k_{ddphi} depends on the dynamic steering head angle and vehicle parameters and/or geometric variables. A further dynamic steering moment portion can in particular be a dynamic brake steering moment M_{dyn_brems}. A simple approach for considering the brake steering moment M_{dyn_brems} is given by: M_{dyn_brems}=k_{brems}*sin (φ)*p_{VR}. Therein, p_{VR} denotes the pressure in the wheel brake formed for braking the vehicle wheel and thus associated with the vehicle wheel, wherein the pressure also referred to as wheel brake pressure or brake pressure in the brake associated with the vehicle wheel depends on the dynamic steering head angle and vehicle parameters and/or geometric variables.

In order to be able to particularly advantageously determine the actual torque value and thus the variable, it can further be provided that the actual torque value is determined, in particular calculated, depending on at least one or more correction terms Mₖₒᵣᵣ. Therein, it is for example conceivable that the stationary value Mₛₜₐₜᵢₒₙ is determined, in particular calculated, depending on the first initial value for example formed as a measurement value and in particular determined by measuring the torque, in particular the steering moment, and depending on the second initial value, for example in that the second initial value (M_{dynamisch}) and the at least one correction term Mₖₒᵣᵣ are subtracted from the first initial value. Since the first initial value is for example determined in that the sensor device measures the torque acting in the steering, in particular steering moment, the first initial value is for example a measurement value, which characterizes the measured torque and thus the moment signal and therein is for example a constituent of the moment signal. For example, the correction term Mₖₒᵣᵣ is a correction torque also referred to as correction value, which is subtracted from the first initial value (Mₘₑₛₛ), in particular in addition to the second initial value. Thus, the actual torque value or Mₛₜₐₜᵢₒₙ for example results from: Mₛₜₐₜᵢₒₙ=Mₘₑₛₛ−M_{dynamisch}−Mₖₒᵣᵣ. The correction term Mₖₒᵣᵣ is for example a simple linear correction term in the form of M_{korr_x}=kₓ*x. The correction term Mₖₒᵣᵣ for example formed as a linear correction term is for example dependent on a driving dynamics variable denoted by x and for example measured, in particular on one of the previously mentioned driving dynamics variables, which is denoted by x. Alternatively or additionally, the in particular linear correction term Mₖₒᵣᵣ is for example a correction term depending on speed in the form of M_{korr_v_x}=k_{v_x}*v*x.

The sensor device for capturing the measurement variable is or includes for example at least one sensor, by means of which the measurement variable or the relative position is captured. For example, the sensor is a force and/or pressure sensor. By means of the sensor, a load of the seat assembly in particular caused by the person can for example be captured, wherein the relative position can be advantageously captured by capturing the load of the seat assembly. In particular, it can be provided that the position value is or characterizes the load of the seat assembly.

Basically, the method according to the invention is intended for a normal drive, also referred to as road drive, along a roadway for example formed as a road, in which marked leaning-out or leaning-in riding styles are not usual. For riders, who ride such riding styles, however, it is advantageous to capture and to consider the position of the rider in relation to the vehicle and thus for example a torso movement and/or torso position of the person using the vehicle and/or a weight transfer of the person using the vehicle, in particular such that the influence value for example denoted by M_{Fahrer} is eliminated. This is for example effected such that the influence value M_{Fahrer} is subtracted from the first initial value. Thus, the influence value denoted by M_{Fahrer} is, describes or defines an influence of the position and thus for example a movement of the person using the vehicle on the steering moment. Thus, the stationary moment M_{stationär} for example results from: M_{stationär}=first initial value (Mₘₑₛₛ)−M_{dynamisch}−M_{Fahrer}.

As described above, Mₖₒᵣᵣ can for example be additionally subtracted from the first initial value. Hereby, the actual torque value and consequently the variable can be particularly advantageously determined.

For highly dynamic driving situations, in which a particularly high accuracy of a determination, in particular estimation, of the stationary steering moment portion, hence the stationary value M_{stationär}, cannot necessarily and readily be realized, the friction value recognition can for example be temporarily suspended, in particular until a driving state of the vehicle suitable for the friction value recognition is again recognized via a driving situation classification. For driving situation classification, which can for example be realized via a method based on threshold value, the measured driving dynamics signals or driving dynamics variables are used. For example, upon straight drive of the vehicle as well as optionally with only very small leaning positions or roll angles below a limit, the friction value recognition can be suspended. The method was also described in context of a person using the vehicle such as for example the rider, who drives and thus controls the vehicle. However, the method according to the invention can also be applied to autonomous vehicles such as for example autonomous, in particular single-track, two-wheeled vehicles, in which the steering moment and thus for example the first initial value Mₘₑₛₛ is exclusively, in particular automatically, adjusted by a system of the vehicle, and/or for assisted and/or partially autonomous vehicles, in which the steering moment is composed of a steering moment adjusted by a system of the vehicle and a steering moment adjusted by a person.

Finally, it has proven to be particularly advantageous if the vehicle is formed as a single-track two-wheeled vehicle, in particular as a single-track motorcycle or motorbike. In particular in such a single-track two-wheeled vehicle, the actual torque value and consequently the variable can be particularly advantageously determined by the method.

A second aspect of the invention relates to a vehicle, which is formed for performing a method according to the first aspect of the invention. Advantages and advantageous configurations of the first aspect of the invention are to be regarded as advantages and advantageous configurations of the second aspect of the invention and vice versa.

Further, the use of a second reference characteristic map in particular provided in addition to the reference characteristic map is for example conceivable. Herein, for example depending on the actual pair of values, one of the second reference pairs of values is selected as the second pair of values associated with the actual pair of values from the second reference characteristic map determined for a second reference friction value different from the reference friction value, which includes multiple, second reference angle values, multiple, second reference speed values and multiple, second reference torque values, and associates exactly one of the second reference torques with a respective second reference pair of values, which includes exactly one of the second reference angle values and exactly one of the second reference speed values. This is for example effected by means of the electronic computing device. By means of the electronic computing device, the second reference torque value associated with the selected, second reference pair of values is determined. By means of the electronic computing device, the determined, second reference torque value is compared to the determined actual torque value. Therein, the variable is determined depending on the comparison of the second reference torque value to the actual torque value. For example, if the actual torque value is between the first reference torque value and the second reference torque value, thus, the variable is for example determined, in particular calculated and thus for example estimated, from the first reference friction value and the second reference friction value, in particular by interpolation. Thus, the current actual friction value or the current friction, in particular the variable, can for example be determined for example by interpolation between the closest friction values. This for example means that those reference torque values read out of the reference characteristic maps are selected, in particular the two reference torques read out of the reference characteristic maps are selected, which are closest to the actual torque value, in particular such that the actual torque value is between the selected reference torque values. Therein, the variable or the actual friction value is for example in particular determined by interpolation from the reference friction values, for which the reference characteristic maps have been determined, from which the closest reference torque values have been read out.

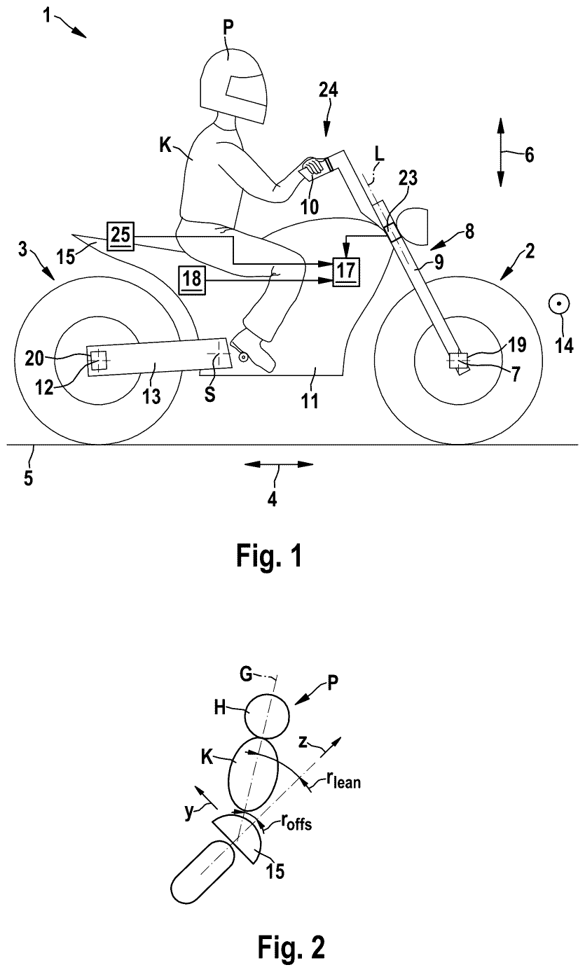

FIG. 1 shows a vehicle 1 presently formed as a single-track two-wheeled vehicle in a schematic side view, which is formed as a single-track motorcycle, in particular as a single-track motorbike, in the embodiment shown in FIG. 1. The vehicle 1 comprises exactly two vehicle wheels, namely a first vehicle wheel 2 and a second vehicle wheel 3. The vehicle wheels 2 and 3 are arranged one behind the other and thus in succession in vehicle longitudinal direction of the vehicle 1. The vehicle longitudinal direction is illustrated by a double arrow 4. In the embodiment shown in FIG. 1, the vehicle wheel 2 is a front wheel and the vehicle wheel 3 is a rear wheel. The vehicle wheels 2 and 3 are also referred to as wheels. The vehicle wheels 2 and 3 are ground contact elements of the vehicle 1, which can be or is downwardly supported on a terrain 5 also referred to as ground or forming a ground via the ground contact elements in vehicle vertical direction of the vehicle 1. Based on FIG. 1 and FIG. 2, a method is described in the following, which is performed during a drive of the vehicle 2, which is formed as a motor vehicle. In the drive and thus in the method, the vehicle 2 is driven along the ground (terrain 5), while the ground contact elements are downwardly directly supported on the ground in vehicle vertical direction of the vehicle 1, such that the vehicle wheels 2 and 3 directly roll on the ground (terrain 5). The vehicle vertical direction of the vehicle 1 is illustrated by a double arrow 6. Thus, if the vehicle 1 is driven along the ground, while the vehicle 1 is downwardly supported on the ground in vehicle vertical direction of the vehicle 1 via the ground contact elements, thus, the ground contact elements, in particular directly, roll on the ground. The vehicle wheel 2 is rotatably retained on a steering element 8 about a wheel rotational axis 7 in relation to the steering element 8 of the vehicle 1. The steering element 8 includes a steering fork 9 and a handle 10 and is pivotably retained on a frame 11 about a pivot axis also referred to as steering axis L in relation to a chassis of the vehicle 1 for example formed as the frame 11. For example, the handle 10 is a handlebar or the handle 10 is formed by a handlebar of the steering element 8. Thus, the steering element 8 and with it the vehicle wheel 2 are pivotable and thus steerable, that is capable of being steered, about the steering axis L in relation to the frame 11. Hereby, cornering maneuvers, driving direction changes and roadway or lane changes of the vehicle 1 can for example be effected, in particular by a person P, in particular currently, using the vehicle 1, such as for example a rider of the vehicle 1 formed as a motor vehicle. The vehicle wheel 3 is rotatably retained on a swingarm 13 about a second wheel rotational axis 12 in relation to the swingarm 13 of the vehicle 1 also referred to as rear wheel swingarm. The swingarm 13 is in turn pivotably retained on the frame 11 about a pivot axis S in relation to the frame 11 such that the swingarm 13 and the vehicle wheel 3 are pivotably retained on the frame 11 about the pivot axis S in relation to the frame 11. Upon straight drive of the vehicle 1, which in particular drives forward and therein in particular along a straight line upon its straight drive in vehicle longitudinal direction, the wheel rotational axes 7 and 12 extend parallel to each other. In addition, the pivot axis S for example extends in vehicle transverse direction of the vehicle 1, the vehicle transverse direction of which is illustrated by a double arrow 14 and extends perpendicularly to the image plane of FIG. 1. It is apparent that the vehicle vertical direction, the vehicle transverse direction and the vehicle longitudinal direction extend perpendicularly to each other in pairs. The vehicle transverse direction is also referred to as y-direction, the vehicle vertical direction is also referred to as z-direction and the vehicle longitudinal direction is also referred to as x-direction. The vehicle transverse direction and the vehicle vertical direction span a plane also referred to as y-z plane, which extends perpendicularly to the image plane of FIG. 1. The vehicle vertical direction is also referred to as vertical axis or vehicle vertical axis and extends along an imagined straight line, wherein the vehicle vertical direction for example extends through the center of mass of the vehicle 1 also referred to as center of gravity.

The vehicle 1 comprises a seat 15 for example retained on the frame 11, which is also referred to seat assembly of the vehicle 1. The seat 15 establishes at least or exactly one seating place, on which the person P currently using the vehicle 1 is currently sitting. Thus, the person P currently using the vehicle 1 is sitting on the seat 15 and thus on the vehicle 1, in particular in a so-called seating point. In particular, it is to be understood hereby that for example the person P contacts the seat 15 in the seating point in particular with their buttocks.

The steering element 8 and thus the handle 10 are constituents of a steering 24 of the vehicle 1 also referred to as steering system, which can be steered by means of the steering 24. The person P sitting on the seat 15 can grip, in particular encompass, the handle 10 with their hands, such that the person P can exert a force or a torque on the handle 10 and thus the steering element 8 and the steering 24 overall via their hands and thus via their arms, which include the hands of the person P. A person torque also referred to as person moment and in particular acting around the steering axis L results from it, by which the steering element 8, in particular the steering 24, and the vehicle wheel 2 can be pivoted about the steering axis L in relation to the frame 11 to thereby steer the vehicle 1. Hereby, the person P can effect cornering maneuvers, driving direction changes and lane changes of the vehicle 1, hence steer the vehicle 1. Again put in other words, the steering element 8, in particular the steering 24, and the vehicle wheel 2 with the steering element 8 are pivotable about the steering axis L in relation to the frame 11 for steering the vehicle 1.

The vehicle 1 comprises an electronic computing device 17 also referred to as control device, by means of which the method is performed.

For example, the vehicle 1 comprises a capturing device 18, which for example is or includes measurement technology. By means of the capturing device 18, accelerations of the vehicle 1 and therein for example accelerations of the vehicle 1 extending in vehicle transverse direction and/or in vehicle longitudinal direction and/or in vehicle vertical direction can for example be captured. For example, a roll angle of the vehicle 1 can for example be captured by means of the capturing device 18. Further, it is conceivable that a roll rate as a time derivative of the roll angle and/or a roll acceleration as a second time derivative of the roll angle, hence as a first time derivative of the roll rate, and/or a yaw acceleration of the vehicle 1 can be captured by means of the capturing device 18.

The vehicle 1 comprises a wheel rotational speed sensor 19 associated with the vehicle wheel 2 and simply also referred to as rotational speed sensor, by means of which a rotational speed of the vehicle wheel 2 about the wheel rotational axis 7 can be captured. Furthermore, the vehicle 1 comprises a wheel rotational speed sensor 20 simply also referred to as rotational speed sensor, associated with the vehicle wheel 3, by means of which a rotational speed of the vehicle wheel 3 about the wheel rotational axis 12 can be captured. For example, a respective wheel brake is associated with the respective vehicle wheel 2, 3. The respective wheel brake can be a friction brake. In particular, the respective wheel brake can be formed as a respective disk brake. Preferably, the respective wheel brake is a service brake of the vehicle 1, which can be braked by means of the respective service brake. Therein, the vehicle 1 can for example comprise a brake pressure sensor, which is associated with the wheel brake associated with the vehicle wheel 2. The wheel brake associated with the vehicle wheel 2 is also referred to as first wheel brake, wherein a first brake pressure simply also referred to as first pressure in the first wheel brake can be captured by means of the previously mentioned brake pressure sensor also referred to as first brake pressure sensor. Further, the vehicle 1 can comprise a second brake pressure sensor, which is associated with the wheel brake associated with the vehicle wheel 3, also referred to as second wheel brake. By means of the second brake pressure sensor, a brake pressure simply also referred to as second pressure in the second wheel brake can be captured. Further, the vehicle 1 for example comprises a steering moment sensor 23, by means of which a steering moment in particular currently acting about the steering axis L in the steering 24 can be captured. The steering moment is a torque acting in the steering 24 (steering system), which can be captured by means of the steering moment sensor 23. By pivoting effected about the steering axis L and in relation to the frame 11 and thus steering the steering element 8 and the vehicle wheel 2, hence the steering 24, a steering angle in particular extending about the steering axis L can be adjusted, that is varied. Optionally, the vehicle 1 can comprise a steering angle sensor, by means of which the steering angle in particular extending about the steering axis L, that is a respective value of the steering angle, can be captured. For effecting the straight drive of the vehicle 1, the steering element 8 and thus the steering 24 are in a straight-ahead position, in which the steering angle is 0 degrees. Optionally, the vehicle 1 can have a steering rate sensor, by means of which a steering rate of the steering element 8 or the steering 24 can be captured. In particular, the steering rate is a time derivative of the steering angle.

The person P in particular currently using the vehicle 1 and most particularly during the method, whose torso is denoted by K, is schematically shown in FIG. 1 in a front view. In particular, FIG. 2 shows the person P during cornering of the vehicle 1, that is while the person P drives the vehicle 1 through a curve, such that the vehicle 1 follows the curve and thus executes cornering. In particular, the vehicle 1 executes cornering during the method. The head of the person P is denoted by H.

An angle extending in the y-z plane, which the torso K of the person P forms with the vehicle vertical direction z also referred to as vertical axis or vehicle vertical axis viewed in the y-z plane, is denoted by rₗₑₐₙ. In particular, an imagined straight line extending through the central point of the body K and/or extending through a body center of gravity of the person P and/or dividing the torso K in two identical halves viewed in the y-z plane forms the angle rₗₑₐₙ with the vehicle vertical direction.

If the torso K is not inclined with respect to the vehicle vertical direction viewed in the y-z plane and thus in vehicle transverse direction of the vehicle 1, such that the mentioned straight line denoted by G in FIG. 2 coincides with the vehicle vertical direction z, thus, the, in particular relative, angle rₗₑₐₙ is zero. Presently, the torso K, hence the straight line G, is inclined with respect to the vehicle vertical direction z viewed in the y-z plane and thus in vehicle transverse direction, such that the angle rₗₑₐₙ has a non-zero value.

A lateral offset, that is extending in vehicle transverse direction of the vehicle 1 and thus in the y-z plane, between the seating point and the vehicle vertical direction z preferably extending through the center of mass of the vehicle 1 also referred to as center of gravity and thus an offset, extending in the y-z plane and thus extending in vehicle transverse direction, between the seating point and the center of gravity of the vehicle 1 is denoted by r_{offs}. If the seating point is on the vehicle vertical direction z, thus, the lateral offset r_{offs} is zero. Presently, the seating point is offset from the center of gravity of the vehicle 1, hence from the vehicle vertical direction z, viewed in the vehicle transverse direction and thus in the y-z plane, such that the lateral offset Toffs has a non-zero value.

In the previously mentioned method, an influence, hence an effect of a relative position between the vehicle 2 and the person P currently using the vehicle 2 on the steering moment currently acting in the steering 24 is determined in particular by means of the electronic computing device 17. The relative position is a seating position of the person P, who is currently sitting on the seat 15 in the seating position. If rₗₑₐₙ and r_{offs} are zero at the same time, thus, the current seating position of the person P currently sitting on the seat 15 and currently using the vehicle 2 is a so-called neutral seating position. If rₗₑₐₙ has a non-zero value and/or if r_{offs} has a non-zero value at the same time, thus, the relative position between the vehicle 2 and the person P is a so-called non-neutral seating position.

The neutral seating position has no or a negligible influence on the steering moment currently acting, in particular overall, in the steering 24. However, the non-neutral seating position has a relatively large, non-negligible influence on the steering moment currently and in particular overall currently acting in the steering 24 such that it is advantageous to determine the previously mentioned influence of the relative position on the steering moment.

In the method, at least one influence value is determined by means of the electronic computing device 17, which characterizes, that is indicates or describes, the influence of the relative position on the steering moment. Hereto, at least one position value is determined in the method by means of the electronic computing device 17, which characterizes a measurement variable captured, that is measured, by means of a, in particular electrical and/or electronic, sensor device, and influenced by the relative position. Depending on the position value, the influence value is determined by means of the electronic computing device 17.

In the embodiment shown in FIG. 1, the sensor device denoted by 25 is a constituent of the vehicle 1, hence a sensor device of the vehicle 1. In the method, the measurement variable is captured by means of the sensor device 25. Hereby, the measurement variable and the current relative position can be particularly advantageously measured such that the influence value and thus the influence can be particularly advantageously determined. In addition, it is provided in the method that at least one component of the vehicle 1 and thus the vehicle 1 is operated depending on the influence value. For example, the component is or includes at least one of the wheel brakes and/or a driver assistance system and/or a drive stability system or a drive stability program of the vehicle 1.

List of reference characters

| | |
|---|---|
| 1 | Vehicle |
| 2 | vehicle wheel |
| 3 | vehicle wheel |
| 4 | double arrow |
| 5 | terrain |
| 6 | double arrow |
| 7 | wheel rotational axis |
| 8 | steering element |
| 9 | steering fork |
| 10 | handle |
| 11 | frame |
| 12 | wheel rotational axis |
| 13 | swingarm |
| 14 | double arrow |
| 17 | electronic computing device |
| 18 | capturing device |
| 23 | steering moment sensor |
| 24 | steering |
| 25 | sensor device |
| G | straight line |
| H | head |
| K | torso |
| L | steering axis |
| P | person |
| nₑₐₙ | angle |
| r_{offs} | offset |
| S | pivot axis |
| y | vehicle transverse direction |
| z | vehicle vertical direction |

1. A method for determining at least one influence value, which characterizes an influence of a relative position between a vehicle and a person using the vehicle on a steering moment currently acting in a steering of the vehicle, in which by means of an electronic computing device:
at least one position value is determined, which characterizes a measurement variable captured by means of a sensor device and influenced by the relative position between the person using the vehicle and the vehicle; and
the influence value is determined depending on the position value.

2. The method according to claim 1:
wherein the measurement variable is captured by means of the sensor device.

3. The method according to claim 2:
wherein a sensor device of the vehicle is used as at least a part of the sensor device.

4. The method according to claim 2:
wherein a sensor device arranged at the person is used as at least a part of the sensor device.

5. The method according to claim 2:
wherein a sensor device arranged on at least one piece of clothing of the person is used as at least a part of the sensor device.

6. The method according to claim 1:
wherein at least one actual torque value characterizing the steering moment currently acting in the steering of a vehicle is determined by means of the electronic computing device in that the actual torque value is determined depending on the influence value by means of the electronic computing device.

7. The method according to claim 6:
wherein at least one variable, which characterizes a current friction between a vehicle wheel of the vehicle and a current terrain, is determined by means of the electronic computing device in that by means of the electronic computing device:
at least one actual angle value is determined, which characterizes a current roll angle of the vehicle;
at least one actual speed value is determined, which characterizes a current driving speed of the vehicle and forms an actual pair of values with the associated actual angle value;
depending on the actual pair of values, one of the reference pairs of values is selected as the pair of values associated with the actual pair of values from at least one reference characteristic map determined for a reference friction value, which includes multiple reference angle values, multiple reference speed values and multiple reference torque values, and associates exactly one of the reference torque values with a respective reference pair of values, which includes exactly one of the reference angle values and exactly one of the reference speed values;
the reference torque value associated with the selected reference pair of values is determined;
the determined reference torque value is compared to the determined actual torque value; and
the variable is determined depending on the comparison of the reference torque value to the actual torque value.

8. The method according to claim 1:
wherein the vehicle is formed as a single-track two-wheeled vehicle.

9. A vehicle, which is formed for performing a method for determining at least one influence value, which characterizes an influence of a relative position between a vehicle and a person using the vehicle on a steering moment currently acting in a steering of the vehicle, in which by means of an electronic computing device:
at least one position value is determined, which characterizes a measurement variable captured by means of a sensor device and influenced by the relative position between the person using the vehicle and the vehicle; and
the influence value is determined depending on the position value.
